(19) United States
(12) Patent Application Publication
(10) Pub. No.: US 2024/0338219 A1
(43) Pub. Date: Oct. 10, 2024

(54) CONFIGURING A PREFETCHER ASSOCIATED WITH A PROCESSOR CORE

(71) Applicant: SiFive, Inc., Santa Clara, CA (US)

(72) Inventors: Paul Walmsley, San Mateo, CA (US); John Ingalls, Sunnyvale, CA (US); Benoy Alexander, Cedar Park, TX (US)

(73) Assignee: SiFive, Inc., Santa Clara, CA (US)

(21) Appl. No.: 18/747,412

(22) Filed: Jun. 18, 2024

Related U.S. Application Data
(63) Continuation of application No. PCT/US2022/051084, filed on Nov. 28, 2022.
(60) Provisional application No. 63/292,871, filed on Dec. 22, 2021.

(51) Int. Cl. G06F 9/38

(52) U.S. Cl. CPC G06F 9/3802

(57) ABSTRACT

Disclosed are systems and methods for configuring a prefetcher. A process may reconfigure a prefetcher associated with a processor core responsive to a context switch. The context switch may comprise the processor core changing from executing a first process to a second process. In some implementations, reconfiguring the prefetcher may include updating a register controlling an operation of the prefetcher from a first set of parameters associated with the first process to a second set of parameters associated with the second process. In some implementations, the second set of parameters may be based on input from a process executed in a user mode.

### CROSS-REFERENCES TO RELATED APPLICATIONS

This application is a continuation of International Application No. PCT/US2022/051084, filed Nov. 28, 2022, which claims priority to U.S. Provisional Application No. 63/292,871, filed Dec. 22, 2021, the entire contents of which are incorporated herein by references for all purposes.

### FIELD OF TECHNOLOGY

This disclosure relates generally to processors, and more specifically, to configuring a prefetcher associated with a processor core.

### BACKGROUND

A prefetcher is used to retrieve data from memory, prior to the data being requested by a central processing unit (CPU) or processor core, in order to reduce the waiting time for memory which may then improve the throughput of the processor core. The prefetcher predictively reads memory locations before they are requested based on how the prefetcher is designed, which may include parameters that may be set at the initialization of the prefetcher. For example, if a process is reading every 64^{th} byte of a large array and the accesses are missing in a level 1 (L1) cache associated with the processor core, the prefetcher may detect these misses. The prefetcher may then allocate the appropriate memory addresses to the level 2 (L2) cache, so that subsequent accesses to the array will hit in the L2 cache. This may reduce overall access time to the array and improve the performance of the process (e.g., the application).

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a block diagram of an example of a system that includes a processor core associated with a prefetcher.

FIG. 2 is a block diagram of another example of a system that includes a processor core associated with a prefetcher.

FIG. 3 is a block diagram of another example of a system that includes a processor core associated with a prefetcher.

FIG. 4 is a block diagram of an example of a system that configures a prefetcher associated with a processor core.

FIG. 5 is a flow chart of an example of a process for a configuring a prefetcher associated with a processor core on a per process basis.

FIG. 6 is a flow chart of an example of a process for a configuring a prefetcher associated with a processor core based on user input.

FIG. 7 is a flow chart of an example of a process for a configuring a prefetcher associated with a processor core and associated with a privilege mode.

FIG. 8 is a block diagram of an example of a system for facilitating generation and manufacture of integrated circuits.

FIG. 9 is a block diagram of an example of a system for facilitating generation of a circuit representation.

### DETAILED DESCRIPTION

A central processing unit (CPU) or processor core may experience latency when fetching data from memory (e.g., when fetching instructions or data from cache or main memory). For example, fetching data from memory may involve the processor core initiating a request to a memory controller and waiting for the memory controller to retrieve the data from memory. Additionally, the processor core might compete with other processor cores and/or direct memory access (DMA) controllers for accessing the memory. To reduce latency, the processor core may use a prefetcher to fetch data from memory in advance of when the data may be used by a process executing in the processor core (e.g., a “prefetch,” or simply a “fetch”). A kernel of an operating system hosting the process may configure the prefetcher, such as by applying a set of parameters to one or more registers controlling operation of the prefetcher. Configuring the prefetcher may permit controlling how the prefetcher fetches data from memory (e.g., controlling one or more characteristics associated with fetching data from memory). For example, the kernel may configure the prefetcher to control a number of streams that the prefetcher will track, a distance associated with a fetch (e.g., a separation between a prefetch tail pointer and a demand pointer), a window associated with a fetch (e.g., a number of cache lines to detect an address match), and/or a size associated with a fetch.

Different processes executing in the processor core could possibly have different memory access patterns. For example, a web browser may have a memory access pattern that is different than a mathematically intensive application which may be executing many matrix multiplication operations. It may be desirable to change the configuration of a prefetcher for a given process, based on its memory access pattern, in order to optimize fetching data from memory for the process (e.g., improve the accuracy of the fetch).

Techniques described herein permit changing a set of parameters being used by a prefetcher on a per process basis at run time. The set of parameters may be changed responsive to a context switch where a processor core changes from executing a first process to a second process. For example, a set of parameters (colloquially knobs) may be changed for a given process based on a memory access pattern associated with the process. The set of parameters may be applied to one or more registers controlling operation of a prefetcher. Changing the set of parameters may permit controlling one or more characteristics associated with fetching data from memory (e.g., how the prefetcher fetches the data from memory). For example, changing the set of parameters may permit controlling one or more characteristics, such as a number of streams that the prefetcher will track, a distance associated with a fetch, a window associated with a fetch, allowing a linear to exponentially increasing distance, and/or a size associated with a fetch. As a result, changing the set of parameters may control a level of aggressiveness when fetching data (e.g., fetching more data in advance for a process versus a risk of fetching data that might go unused or under used by the process). The set of parameters may be applied to one or more registers controlling operation of the prefetcher which may be protected (e.g., accessible in a higher privileged mode than a mode associated with a user mode). In some implementations, the set of parameters may be controlled by a kernel of an operating system (e.g., Linux®) that is executing in the higher privileged mode. A process executing in a lower privileged mode (e.g., a user mode) may provide input for changing the set of parameters for a given process. The kernel may receive the input and configure (or reconfigure) the set of parameters for the prefetcher based on the input. In some implementations, the process that provides the input may be the same process for which the prefetcher will fetch data. In some implementations, the process that provides the input may be a system management process that is separate from the process for which the prefetcher will fetch data. Thus, the configuration of a prefetcher may be changed dynamically, on a per process basis at run time, so as to optimize the fetching of data from memory for a given process. In some implementations, the configuration of a prefetcher may be changed for a process based on a memory access pattern associated with the process.

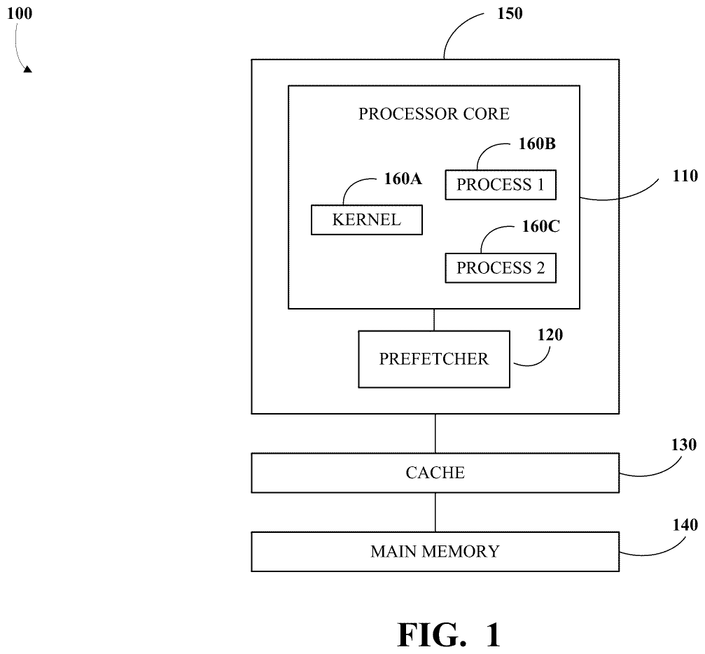

FIG. 1 is a block diagram of an example of a system 100 that includes a processor core associated with a prefetcher. The system 100 may include a processor core 110, a prefetcher 120 associated with the processor core 110, and a memory system (e.g., “memory”), such as a cache system 130 and/or a main memory system 140. The processor core 110 and the prefetcher 120 may be associated with one another in a processing node 150 (e.g., a tile). In some implementations, the processing node 150 may be implemented with other processing nodes in a cluster. The processing node 150 may be implemented in an integrated circuit (IC), such as an application-specific integrated circuit (ASIC) or system on a chip (SoC). The processor core 110 may include a level 1 (L1) cache which may be divided into an instruction level 1 (IL1) cache and/or a data level 1 (DL1) cache. The cache system 130 may implement a cache controller and a cache memory (e.g., static random access memory (SRAM)) for the processing node 150. For example, the cache system 130 may implement a private level 2 (L2) cache associated with the processing node 150, and/or a shared level 3 (L3) cache associated with multiple processing nodes, including the processing node 150. The main memory system 140 may implement a memory controller and a main memory (e.g., dynamic random access memory (DRAM)) associated with one or more processing nodes, including the processing node 150.

The processor core 110 may include an execution unit for executing instructions and processing data and may be implemented with other processor cores. For example, the processor core 110 could be a RISC-V processor. The processor core 110 may execute one process or task at a time, such as executing one of process 160A (e.g., a kernel of an operating system such as Linux), process 160B (e.g., a process associated with a user application being hosted by the operating system, such as a web browser), and process 160C (e.g., another process associated with a user application being hosted by the operating system, such as a mathematically intensive program). Such processes may be uniquely identified in the system by a process identifier (PID). Additionally, the processor core 110 may switch between executing different processes based on an event (e.g., context switching, or multitasking), such as switching from executing process 160A to executing process 160B or switching from executing process 160B to executing process 160C. For example, when executing a first process (e.g., process 160A), a second process (e.g., process 160B) may held in suspension (or might not have started). Then, an event (or trigger) may cause a context switch to occur, such as a timeout associated with executing the first process or an interrupt associated with the second process. In such an event, context data associated with the first process (e.g., contents of the general purpose registers of the processor core 110, and/or a memory map or set of addresses available to the first process) may be saved, and context data associated with the second process (e.g., contents of the general purpose registers of the processor core 110, and/or a memory map or set of addresses available to the second process) may be restored (or generated if the second process has not yet started). Then, the processor core 110 may resume (or begin) executing the second process while holding the first process in suspension.

To reduce latency in the system 100, the prefetcher 120 may fetch data from the memory system for one or more processes executing in the processor core 110 in advance of when the data may be used by the one or more processes. For example, the prefetcher 120 may fetch data from the memory system for the process 160B (e.g., the web browser) when the processor core 110 is executing process 160B. The prefetcher 120 may fetch the data for the process 160B in advance of when the data may be used by the process 160B. The prefetcher 120 may also fetch data from the memory system for the process 160C (e.g., the mathematically intensive program) when the processor core 110 is the executing process 160C. The prefetcher 120 may fetch such data for the process 160C in advance of when the data may be used by the process 160C.

The prefetcher 120 may be configured to use a set of parameters (e.g., a first set of parameters) that controls one or more characteristics associated with fetching data from memory. For example, the set of parameters may configure the prefetcher to control a number of streams that the prefetcher will track, a distance associated with a fetch, a window associated with a fetch, allowing a linear to exponentially increasing distance, and/or a size associated with a fetch. For example, the prefetcher 120 may be configured with the set of parameters for when the processor core 110 executes process 160B. In some implementations, the set of parameters may be a default set of parameters. The set of parameters may be controlled by a kernel of an operating system hosting the one or more processes executing in the processor core 110, such as the process 160A (e.g., the kernel).

The set of parameters may be changed on a per process basis at run time (e.g., during execution of a process in the processor core 110). For example, the prefetcher 120 may be configured again (or reconfigured) with another set of parameters (e.g., a second set of parameters) for use with a process. For example, the prefetcher 120 may be reconfigured with the second set of parameters for when the processor core 110 executes process 160B. In some implementations, the second set of parameters may be optimized for a memory access pattern that is associated with the process 160B (e.g., the web browser). Changing from the first set of parameters to the second set of parameters may permit changing the one or more characteristics associated with fetching data from memory. For example, changing from the first set of parameters to the second set of parameters may permit changing the number of streams that the prefetcher will track, the distance associated with the fetch, the window associated with the fetch, allowing a linear to exponentially increasing distance, and/or the size associated with the fetch. This may permit optimizing the one or more characteristics associated with fetching data from memory based on the memory access pattern associated with process (e.g., process 160B).

Further, the prefetcher 120 may be configured again (or reconfigured) with a third set of parameters for when the processor core 110 executes process 160C. The third set of parameters may be optimized for a memory access pattern associated with the process 160C (e.g., the mathematically intensive program). Changing from the second set of parameters to the third set of parameters for process 160C may change again the one or more characteristics associated with fetching data from memory. This may permit optimizing the one or more characteristics associated with fetching data from memory based on the memory access pattern associated with the process 160C. The prefetcher 120 may be configured (and reconfigured) many times, on a per process basis at run time, so as to optimize the fetching of data from memory for a given process. Changing the set of parameters may permit optimizing the one or more characteristics associated with fetching data from memory based on the memory access pattern associated with the process.

In some implementations, when a processor core switches from executing a first process to executing a second process (e.g., context switching), the prefetcher 120 may also be reconfigured at that time from using a first set of parameters for the first process to using a second set of parameters for the second process. In other words, switching the set of parameters used to configure the prefetcher 120 may be part of a context switch between a first process and a second process. For example, when the processor core 110 switches from executing process 160B to executing process 160C, the prefetcher 120 may also be reconfigured at that time, such as switching from using the second set of parameters for process 160B to using the third set of parameters for process 160C.

In some implementations, when a new process starts, the prefetcher 120 may be configured with a default set of parameters for the new process. For example, process 160B (e.g., the web browser) may start in the processor core 110. The process 160A (e.g., the kernel) may configure the prefetcher 120 with a default set of parameters for when the processor core 110 executes the process 160B. Then, the process 160A may reconfigure the prefetcher 120 with a second set of parameters for when the processor core 110 executes the process 160B. Also, the process 160C (e.g., the mathematically intensive program) may start in the processor core 110. The process 160A may reconfigure the prefetcher 120 with the default set of parameters for when the processor core 110 executes the process 160C. Then, the process 160C may reconfigure the prefetcher 120 with a third set of parameters for when the processor core 110 executes the process 160B.

In some implementations, when a first process initiates or starts a second process (e.g., a new process), the prefetcher 120 may be configured to use a same set of parameters for the second process as was used for the first process. In other words, if a parent process creates a child process (e.g., forks), the child process may inherit the same set of parameters as the parent process. For example, if process 160B initiates or starts a new process, the prefetcher 120 may be configured with the second set of parameters (e.g., which is the same set of parameters as was used for the process 160B) for when the processor core 110 executes the new process.

In some implementations, when a process moves from a first processor core to a second processor core (e.g., a task migration), a prefetcher associated with the second processor core may be configured to use a same set of parameters when executing the process as a prefetcher associated with the first processor core. In other words, if a process migrates from one processor core to another, the set of parameters may follow the process from the one processor core to the other. For example, if the process 160B moves from the processor core 110 to another processor core, a prefetcher associated with the other processor core may be configured to use the same set of parameters when executing the process 160B as the prefetcher 120 associated with the first processor core 110 used when executing the process 160B.

In some implementations, a process that the prefetcher 120 will fetch data for may provide input for changing the set of parameters. For example, the process 160B may provide input to the process 160A for changing the set of parameters, such as by making a system call and/or writing to a data structure in a virtual file system (e.g., a proc filesystem (procfs) in Linux). The virtual file system may provide a way for user space programs (e.g., the process 160B) to communicate with the kernel (e.g., process 160A). The process 160A may configure (or reconfigure) the prefetcher 120 with the set of parameters, based on the input from the process (e.g., process 160B), for when the processor core 110 executes the process (e.g., the process 160B). In some implementations, one process (e.g., a system management process) may provide input for changing the set of parameters for another process, such as by writing to a data structure in a virtual file system (e.g., procfs). For example, process 160C may provide input to process 160A for changing the set of parameters for when the processor core 110 executes process 160B. Then, process 160A may configure (or reconfigure) the prefetcher 120 with a set of parameters, based on the input from process 160C, for when the processor core 110 executes process 160B.

In some implementations, the prefetcher 120 may track the success of fetching data from memory for a given process (e.g., a usefulness of the fetches, such as tracking a number of fetches in which the data is unused or under used). The prefetcher 120 may then change the set of parameters to improve the success of the fetches, analogous to machine learning.

In some implementations, the prefetcher 120 may be disabled or turned off so that the prefetcher 120 does not fetch data from memory in advance of a process. For example, the prefetcher 120 may be disabled or turned off by the kernel (e.g., process 160A). The prefetcher 120 may be disabled or turned off globally (e.g., for all processes executing in the processor core 110) or individually (e.g., for one or more processes executing in the processor core 110). In some implementations, the prefetcher 120 may be disabled or turned off to reduce power consumption (e.g., part of a power savings mode). In some implementations, the prefetcher 120 may be disabled or turned off based on exceeding a number of unsuccessful fetches (e.g., exceeding a number of fetches in which the data is unused or under used).

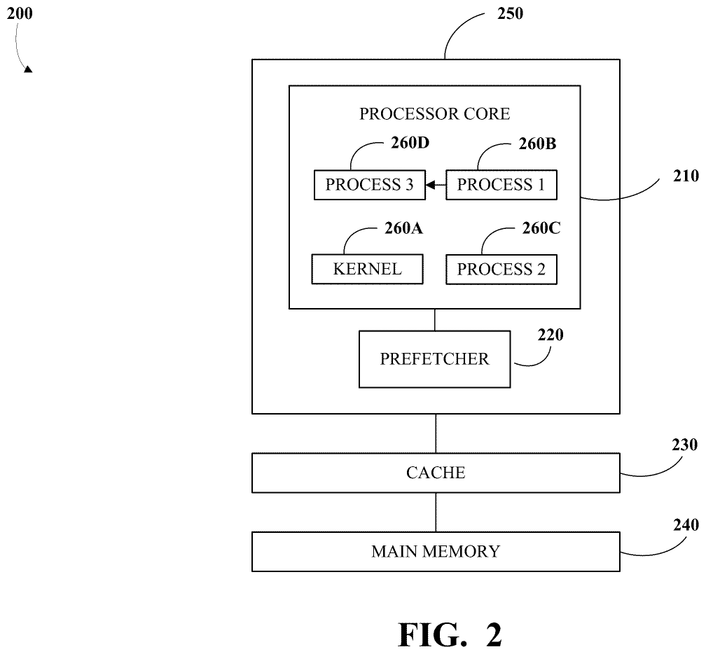

FIG. 2 is a block diagram of another example of a system 200 that includes a processor core associated with a prefetcher. The system 200 may be like the system 100 shown in FIG. 1. In the system 200, a process 260B may be executing in a processor core 210 associated with a prefetcher 220. The process 260B may execute to initiate or start a process 260D (e.g., the process 260B may fork). The prefetcher 220 may be configured to use a same set of parameters for the process 260D (when the processor core 210 executes the process 260D) as for the process 260B (when the processor core 210 executes the process 260B). In other words, the process 260D may inherit the same set of parameters for prefetching as the process 260B.

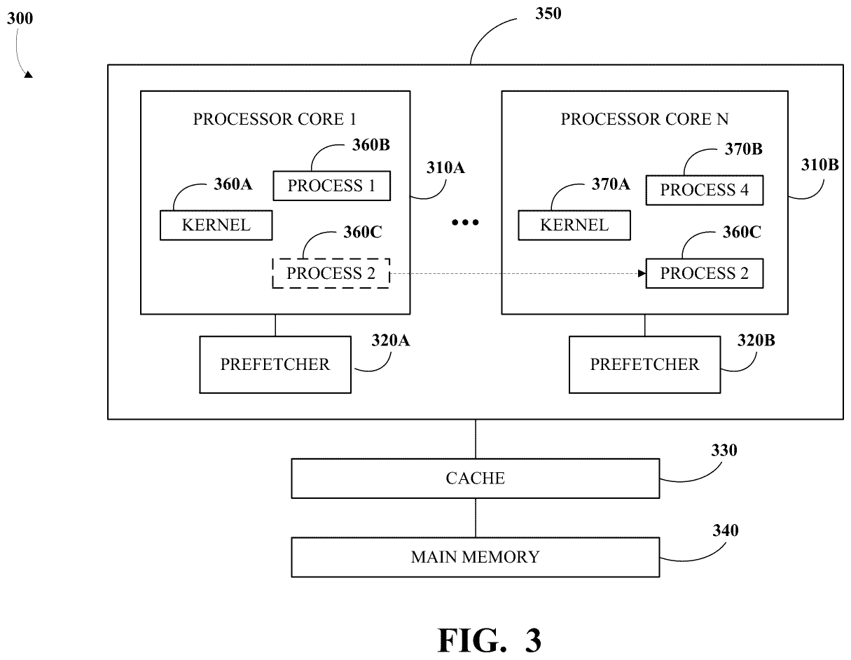

FIG. 3 is a block diagram of another example of a system 300 that includes a processor core associated with a prefetcher. The system 300 may be like the system 100 shown in FIG. 1 or the system 200 shown in FIG. 2. The system 300 may include multiple processor cores, such as processor cores 310A and 310B. In some implementations, the multiple processor cores may be associated with one another in a cluster. In the system 300, a process 360C may be executing in a processor core 310A associated with a prefetcher 320A. The prefetcher 320A may be configured with a set of parameters when executing the process 360C. Then, the process 360C may move from executing in the processor core 310A to executing in the processor core 310B (e.g., task migration). A prefetcher 320B, associated with the processor core 310B, may be configured with the same set of parameters when executing the process 360C. In other words, when the process 360C migrates from the processor core 310A to the processor core 310B, the same set of parameters used to configure the prefetcher 320A for when the process 360C executes in the processor core 310A may be used to configure the prefetcher 320B for when with the process 360C executes in the processor core 310B.

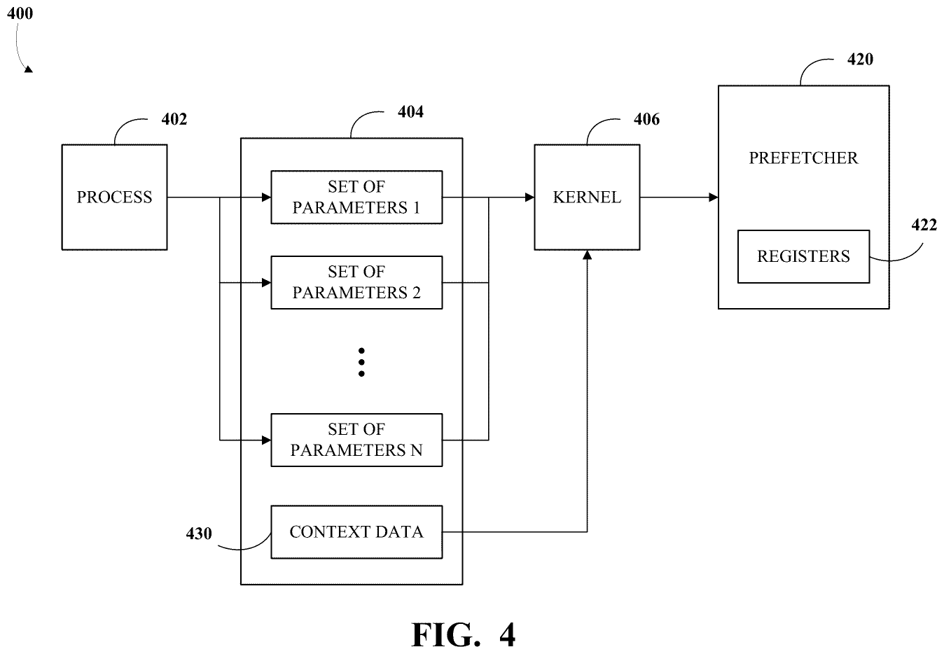

FIG. 4 is a block diagram of an example of a system 400 that configures a prefetcher associated with a processor core. The system may include a user process 402 (e.g., a process that executes in a user mode), a data structure 404, a control process 406 (e.g., the kernel of an operating system), and a prefetcher 420. The process 402 may be like the process 160B or the process 160C shown in FIG. 1, the process 260B or the process 260C or the process 260D shown in FIG. 2, or the process 360B or the process 360C shown in FIG. 3. The control process 406 may be like the process 160A shown in FIG. 1, the process 260A shown in FIG. 2, or the process 360A shown in FIG. 3. The prefetcher 420 may be like the prefetcher 120 shown in FIG. 1, the prefetcher 220 shown in FIG. 2, or the prefetcher 320 shown in FIG. 3.

The prefetcher 420 may include registers 422 that may be programmed with a set of parameters for controlling operation of the prefetcher 420. Configuring the prefetcher 420 with the set of parameters may control one or more characteristics associated with fetching data from memory for a process, such as a number of streams that the prefetcher will track, a distance associated with a fetch, a window associated with a fetch, allowing a linear to exponentially increasing distance, and/or a size associated with a fetch. In some implementations, the registers 422 may be protected (e.g., accessible in a higher privileged mode than a mode associated with a user mode). The control process 406 (e.g., the kernel) may execute in the higher privileged mode to program the registers 422 with the set of parameters to configure the prefetcher 420. Accordingly, the control process 406 may configure and reconfigure (e.g., change) the set of parameters used by the prefetcher 420 on a per process basis at run time. For example, the control process 406 may program the registers 422 with a first set of parameters for when a first process will be executing and may program the registers 422 with a second set of parameters for when a second process will be executing. For example, the control process 406 may program the registers 422 for a given process when context switching. In some implementations, the control process 406 may initially program the registers 422 with a default set of parameters.

In some implementations, the control process 406 may program the registers 422 based on input from another process executing in a lower privileged mode associated with a user mode, such as the process 402. In some implementations, the process 402 may be a same process for which the prefetcher 420 will fetch data. In some implementations, the process 402 may be a system management process that is separate from a process for which the prefetcher 420 will fetch data. As the registers 422 may be protected, the input may be provided to the control process 406, such as via a system call and/or writing to the data structure 404. The process 402 may provide the input to the control process 406 by writing the input to the data structure 404 (e.g., the data structure 404 may be writeable by a process when the process is executing in the lower privileged mode). For example, the data structure may be part of a virtual file system (e.g., procfs in Linux). The virtual file system may provide a way for user space programs (e.g., the process 402) to communicate the input to the kernel (e.g., the control process 406). The process 402 may write a set of parameters (e.g., “set of parameters 1”) to the data structure 404, such as by writing 32-bits or 64-bits to the data structure 404 (analogous to programming a register). The control process 406 may receive the set of parameters from the data structure 404 as input and may apply the set of parameters (e.g., apply the input) to program the registers 422.

In some implementations, the process 402 may provide input for multiple processes. For example, the process 402 may write to the data structure 404 to provide input including a first set of parameters for use with a first process (e.g., “set of parameters 1”), a second set of parameters for use with a second process (e.g., “set of parameters 2”), and so forth. The control process 406 may receive the input and apply the first set of parameters to program the registers 422 for when the first process will be executing, apply the second set of parameters to program the registers 422 for when the second process will be executing, and so forth. Thus, the configuration of the prefetcher 420 may be changed dynamically, on a per process basis at run time, so as to optimize the fetching of data from memory for a given process.

In some implementations, the data structure 404 may be a same data structure that is used to store context data 430 associated with context switching between processes executing in the processor core (e.g., defined as a “task_struct” structure in Linux). For example, for a given process, the data structure 404 may store the contents of general purpose registers of the processor core, a memory map or set of addresses available to the process, and/or the set of parameters for configuring the prefetcher 420 for use with the process. In some implementations, the set of parameters may be stored in metadata in the data structure 404. For example, when context switching from a first process to a second process, the control process 406 may save a first set of context data associated the first process to the data structure 404 and restore a second set of context data associated with the second process from the data structure 404. Further, when restoring the second set of context data, the control process 406 may access metadata in the data structure 404 to restore the second set of parameters to program the registers 422 for use with the second process.

In some implementations, an interlock may be implemented to prevent an invalid set of parameters from being programmed to the registers 422. The interlock may be used to constrain the set of parameters to valid settings. This may prevent the prefetcher 420 from being configured incorrectly. For example, the interlock may be executed in connection with the process 402 and/or the control process 406. In some implementations, the registers 422 may be located so as to enable updating the register with the set of parameters after using the prefetcher 420 during run time (e.g., as opposed to updating the register with the set of parameters during an initial start-up condition). For example, the registers 422 may be located so as to enable updating the register with a second set of parameters after using the prefetcher 420 during run time with a first set of parameters.

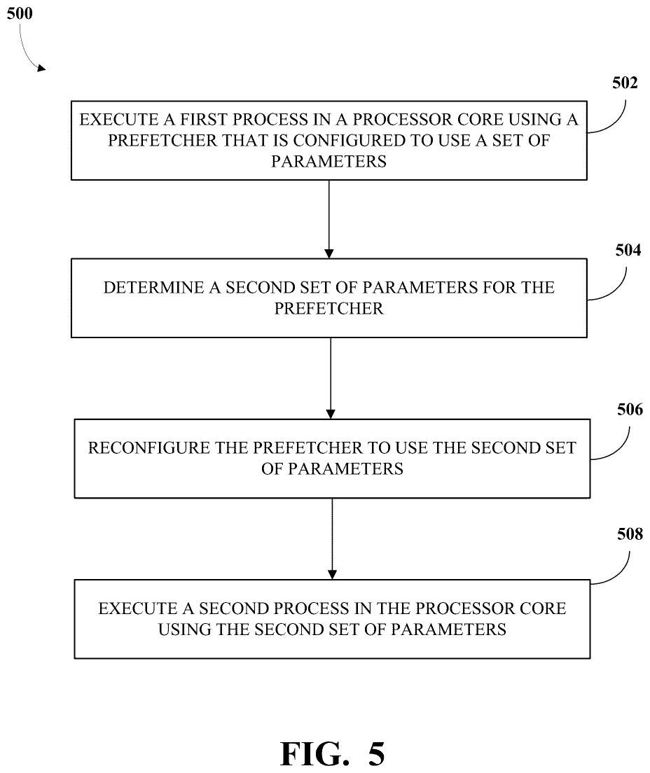

FIG. 5 is a flow chart of an example of a process 500 for a configuring a prefetcher associated with a processor core on a per process basis at run time. The process 500 may include executing 502 a first process in a processor core that is associated with a prefetcher that uses a first set of parameters; determining 504 a second set of parameters for the prefetcher, such as in response to a context switch; reconfiguring 506 the prefetcher to use the second set of parameters; and executing 508 a second process in the processor core with the prefetcher using the second set of parameters. For example, the process 500 may be executed in the system 100 shown in FIG. 1, the system 200 shown in FIG. 2, the system 300 shown in FIG. 3, and/or the system 400 shown in FIG. 4.

The process 500 may include executing 502 a first process in a processor core that is associated with a prefetcher that uses first set of parameters. The prefetcher may fetch data from memory, such as a cache or main memory. The prefetcher may be configured to use the first set of parameters to control one or more characteristics associated with fetching data from memory, such as a number of streams that the prefetcher will track, a distance associated with a fetch, a window associated with a fetch, allowing a linear to exponentially increasing distance, and/or a size associated with a fetch. The first set of parameters may be a default set of parameters. The first set of parameters may be applied to one or more registers controlling operation of the prefetcher which may be protected (e.g., accessible in a higher privileged mode than a mode associated with a user mode). The process may be executing in a lower privileged mode that is associated with a user mode.

The process 500 may also include determining 504 a second set of parameters for the prefetcher. For example, the second set of parameters may be determined responsive to a context switch from executing the first process to executing the second process. For example, the second set of parameters may be determined by the first process, the second process, a system management process (e.g., which executes in a lower privileged mode and which is separate from the first process and the second process); a control process (e.g., the kernel of an operating system, which executes in a higher privileged and which is operable to configure the prefetcher with the second set of parameters); and/or logic associated with the prefetcher. The second set of parameters may be determined so as to optimize the fetching of data from memory for the second process. In some implementations, the second set of parameters may be determined based on a memory access pattern associated with the second process. In some implementations, the second set of parameters may be determined based on a history of the second process, such as whether the second process forked from another process (e.g., the first process) or whether the second process migrated from another processor core.

The process 500 may also include reconfiguring 506 the prefetcher to use the second set of parameters to control the one or more characteristics associated with fetching data from memory. For example, the prefetcher may be reconfigured responsive to a context switch from executing the first process to executing the second process. The second set of parameters may change the one or more characteristics associated with the fetching. The second set of parameters may be applied to one or more registers controlling operation of the prefetcher, such as by the control process (e.g., kernel) executing in the higher privileged mode.

The process 500 may also include executing 508 the second process in the processor core with the prefetcher using the second set of parameters. The second set of parameters may optimize the fetching of data from memory for the second process.

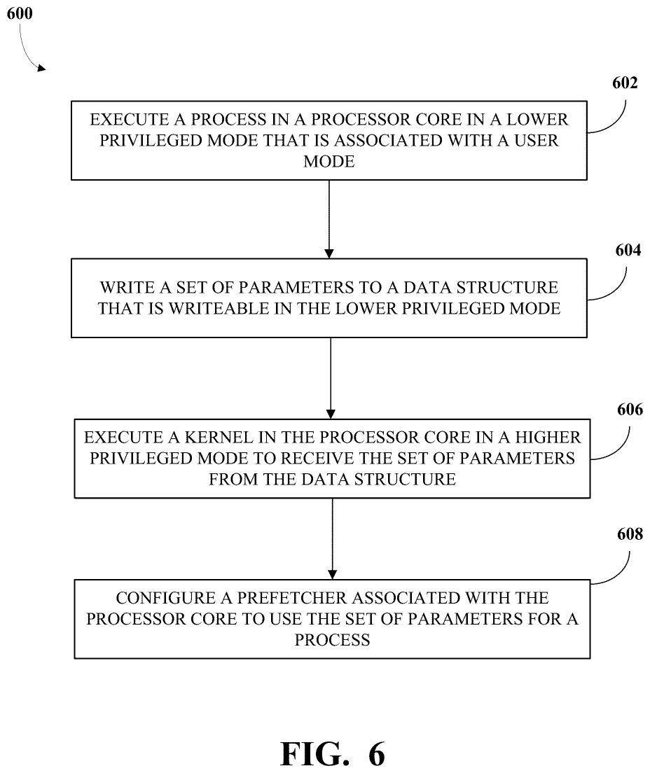

FIG. 6 is a flow chart of an example of a process 600 for a configuring a prefetcher associated with a processor core based on user input. The process 600 may include executing 602 a process in a processor core in a lower privileged mode that is associated with a user mode; writing 604 a set of parameters to a data structure that is writeable in the lower privileged mode and/or making a system call providing the set of parameters; executing 606 a control process (e.g., the kernel of an operating system) in a higher privileged mode than a mode to receive the set of parameters from the data structure and/or the system call; and configuring 608 a prefetcher associated with the processor core to use the set of parameters for a process. For example, the process 600 may be executed in the system 100 shown in FIG. 1, the system 200 shown in FIG. 2, the system 300 shown in FIG. 3, and/or the system 400 shown in FIG. 4.

The process 600 may include executing 602 a process in a processor core in a lower privileged mode that is associated with a user mode. In some implementations, the process may be a same process for which a prefetcher associated with the process core will fetch data. In some implementations, the process may a system management process that is separate from the process for which the prefetcher will fetch data. The process may be associated with a user program.

The process 600 may also include writing 604 a set of parameters to a data structure that is writeable in the lower privileged mode and/or making a system call providing the set of parameters. The process executing in the lower privileged mode may write the set of parameters to the data structure and/or make the system call. The process may write the set of parameters and/or make the system call to provide input to a control process executing in a higher privileged mode. In some implementations, the process may provide the input by writing to a data structure in a virtual file system (e.g., procfs). In some implementations, the process may provide the input as metadata in a data structure that is used to store context data associated with context switching between processes executing in the processor core (e.g., a “task_struct” structure in Linux). The set of parameters may be used to control one or more characteristics associated with fetching data from memory, such as a number of streams that the prefetcher will track, a distance associated with a fetch, a window associated with a fetch, allowing a linear to exponentially increasing distance, and/or a size associated with a fetch.

The process 600 may also include executing 606 a control process (e.g., the kernel of an operating system) in a higher privileged mode than a mode to receive the set of parameters from the data structure and/or the system call. The control process may receive the set of parameters (e.g., input) from the data structure and/or the system call to as provided by the process executing in the lower privileged mode.

The process 600 may also include configuring 608 a prefetcher associated with the processor core to use the set of parameters for a process. The set of parameters may be applied to one or more registers controlling operation of the prefetcher. In some implementations, the set of parameters may be used to configure the prefetcher to fetch data from memory for the process that provided the input. The set of parameters may configure (or reconfigure) the prefetcher to control one or more characteristics associated with fetching data from memory and/or may change the one or more characteristics associated the fetching. In some implementations, the set of parameters may optimize fetching data from memory for a process based on a memory access pattern of the process.

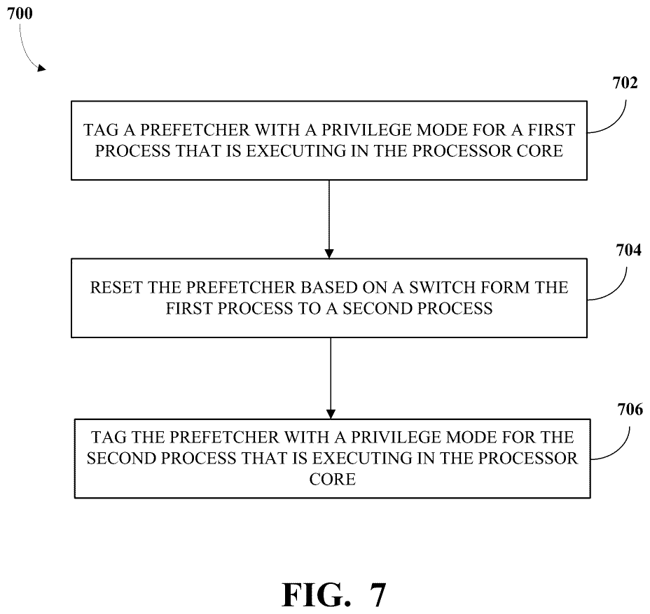

FIG. 7 is a flow chart of an example of a process 700 for a configuring a prefetcher associated with a processor core and associated with a privilege mode. The process 700 may include tagging 702 a prefetcher associated with a processor core with a privilege mode for a first process that is executing in the processor core; resetting 704 the prefetcher based on a switch from the first process to a second process; and tagging 706 the prefetcher with a privilege mode for a second process that is executing in the processor core. For example, the prefetcher may be configured to contain data between first and second processes in a security context, so that information (e.g., a history of fetches) from one process is inaccessible to another process. For example, the process 700 may be executed in the system 100 shown in FIG. 1, the system 200 shown in FIG. 2, the system 300 shown in FIG. 3, and/or the system 400 shown in FIG. 4.

The process 700 may include tagging 702 a prefetcher associated with a processor core with a privilege mode for a first process that is executing in the processor core. The privilege mode for the first process may be broadcasted to one or more functional units in the processor core. The prefetcher may be configured to use a first set of parameters when fetching data from memory for the first process. The first set of parameters may be based on user input. The prefetcher may fetch data for the first process based on the first set of parameters. In some implementations, the prefetcher may include training for improving fetches for the first process (e.g., a trained state), analogous to machine learning, in the privilege mode.

The process 700 may also include resetting 704 the prefetcher based on a switch from the first process to a second process. For example, resetting may occur prior to a context switch from the first process to the second process. In some implementations, the context switch may trigger the reset to occur (e.g., a run time reset). In some implementations, reconfiguring the prefetcher with a second set of parameters may trigger the reset to occur. In other words, the prefetcher may detect a process change and reset in response to the process change (e.g., clear the history associated with the fetches). In some implementations, the prefetcher may be reset in order to contain data associated with the first process from the second process, so that information (e.g., a history of fetches) from the first process is inaccessible to the second process. For example, the trained state associated with fetching data for the first process may be inaccessible to the second process following the reset (e.g., the prefetcher may be cleared). In some implementations, the prefetcher may be reset in one clock cycle.

The process 700 may also include tagging 706 the prefetcher with a privilege mode for the second process that is executing in the processor core. The privilege mode for the second process may also be broadcasted to the one or more functional units in the processor core. In some implementations, the second process may carry over the privilege mode of the first process (e.g., execute in a privilege mode having the same settings as the first process). The prefetcher may be configured to use the second set of parameters when fetching data from memory for the second process. The second set of parameters may be based on user input. The prefetcher may fetch data for the second process based on the second set of parameters. In some implementations, the prefetcher may include training for improving fetches for the second process (e.g., a trained state), analogous to machine learning, in the privilege mode.

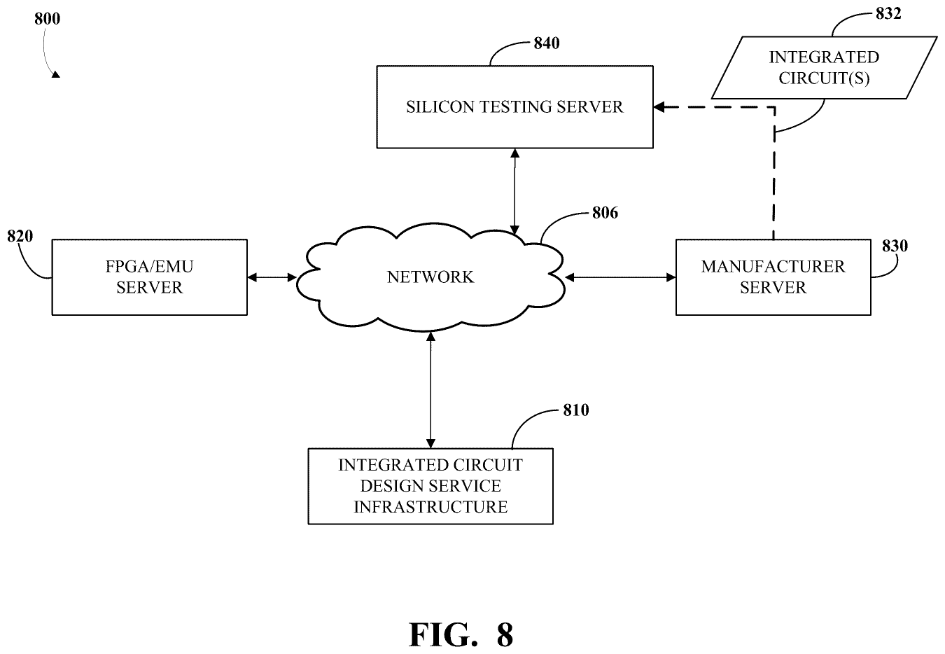

FIG. 8 is a block diagram of an example of a system 800 for generation and manufacture of integrated circuits. The system 800 includes a network 806, an integrated circuit design service infrastructure 810 (e.g., integrated circuit generator), a field programmable gate array (FPGA)/emulator server 820, and a manufacturer server 830. For example, a user may utilize a web client or a scripting application program interface (API) client to command the integrated circuit design service infrastructure 810 to automatically generate an integrated circuit design based on a set of design parameter values selected by the user for one or more template integrated circuit designs. In some implementations, the integrated circuit design service infrastructure 810 may be configured to generate an integrated circuit design that includes the circuitry shown and described in FIGS. 1-4.

The integrated circuit design service infrastructure 810 may include a register-transfer level (RTL) service module configured to generate an RTL data structure for the integrated circuit based on a design parameters data structure. For example, the RTL service module may be implemented as Scala code. For example, the RTL service module may be implemented using Chisel. For example, the RTL service module may be implemented using flexible intermediate representation for register-transfer level (FIRRTL) and/or a FIRRTL compiler. For example, the RTL service module may be implemented using Diplomacy. For example, the RTL service module may enable a well-designed chip to be automatically developed from a high level set of configuration settings using a mix of Diplomacy, Chisel, and FIRRTL. The RTL service module may take the design parameters data structure (e.g., a java script object notation (JSON) file) as input and output an RTL data structure (e.g., a Verilog file) for the chip.

In some implementations, the integrated circuit design service infrastructure 810 may invoke (e.g., via network communications over the network 806) testing of the resulting design that is performed by the FPGA/emulation server 820 that is running one or more FPGAs or other types of hardware or software emulators. For example, the integrated circuit design service infrastructure 810 may invoke a test using a field programmable gate array, programmed based on a field programmable gate array emulation data structure, to obtain an emulation result. The field programmable gate array may be operating on the FPGA/emulation server 820, which may be a cloud server. Test results may be returned by the FPGA/emulation server 820 to the integrated circuit design service infrastructure 810 and relayed in a useful format to the user (e.g., via a web client or a scripting API client).

The integrated circuit design service infrastructure 810 may also facilitate the manufacture of integrated circuits using the integrated circuit design in a manufacturing facility associated with the manufacturer server 830. In some implementations, a physical design specification (e.g., a graphic data system (GDS) file, such as a GDSII file) based on a physical design data structure for the integrated circuit is transmitted to the manufacturer server 830 to invoke manufacturing of the integrated circuit (e.g., using manufacturing equipment of the associated manufacturer). For example, the manufacturer server 830 may host a foundry tape-out website that is configured to receive physical design specifications (e.g., such as a GDSII file or an open artwork system interchange standard (OASIS) file) to schedule or otherwise facilitate fabrication of integrated circuits. In some implementations, the integrated circuit design service infrastructure 810 supports multi-tenancy to allow multiple integrated circuit designs (e.g., from one or more users) to share fixed costs of manufacturing (e.g., reticle/mask generation, and/or shuttles wafer tests). For example, the integrated circuit design service infrastructure 810 may use a fixed package (e.g., a quasi-standardized packaging) that is defined to reduce fixed costs and facilitate sharing of reticle/mask, wafer test, and other fixed manufacturing costs. For example, the physical design specification may include one or more physical designs from one or more respective physical design data structures in order to facilitate multi-tenancy manufacturing.

In response to the transmission of the physical design specification, the manufacturer associated with the manufacturer server 830 may fabricate and/or test integrated circuits based on the integrated circuit design. For example, the associated manufacturer (e.g., a foundry) may perform optical proximity correction (OPC) and similar post-tape-out/pre-production processing, fabricate the integrated circuit(s) 832, update the integrated circuit design service infrastructure 810 (e.g., via communications with a controller or a web application server) periodically or asynchronously on the status of the manufacturing process, perform appropriate testing (e.g., wafer testing), and send to a packaging house for packaging. A packaging house may receive the finished wafers or dice from the manufacturer and test materials and update the integrated circuit design service infrastructure 810 on the status of the packaging and delivery process periodically or asynchronously. In some implementations, status updates may be relayed to the user when the user checks in using the web interface, and/or the controller might email the user that updates are available.

In some implementations, the resulting integrated circuit(s) 832 (e.g., physical chips) are delivered (e.g., via mail) to a silicon testing service provider associated with a silicon testing server 840. In some implementations, the resulting integrated circuit(s) 832 (e.g., physical chips) are installed in a system controlled by the silicon testing server 840 (e.g., a cloud server), making them quickly accessible to be run and tested remotely using network communications to control the operation of the integrated circuit(s) 832. For example, a login to the silicon testing server 840 controlling a manufactured integrated circuit(s) 832 may be sent to the integrated circuit design service infrastructure 810 and relayed to a user (e.g., via a web client). For example, the integrated circuit design service infrastructure 810 may be used to control testing of one or more integrated circuit(s) 832.

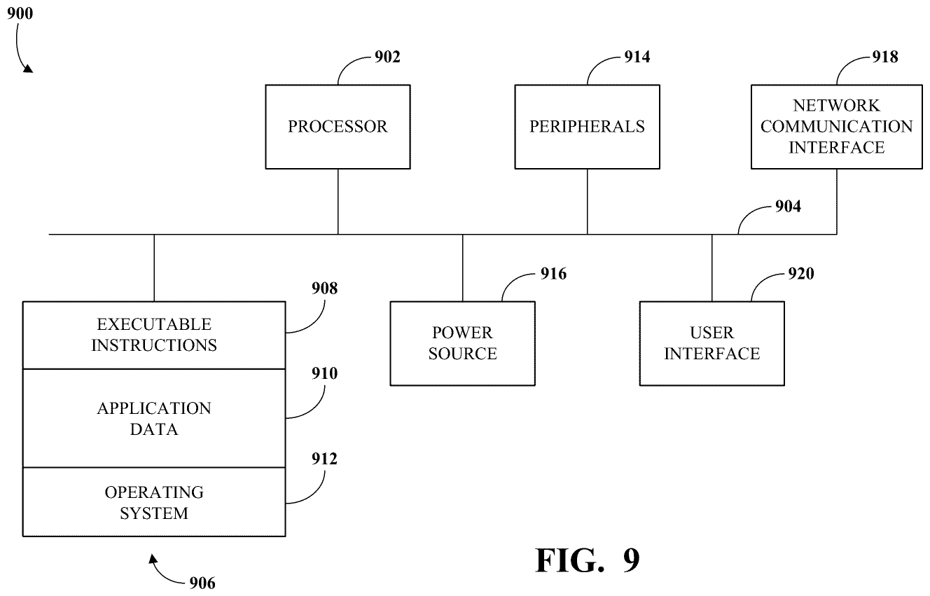

FIG. 9 is a block diagram of an example of a system 900 for facilitating generation of integrated circuits, for facilitating generation of a circuit representation for an integrated circuit, and/or for programming or manufacturing an integrated circuit. The system 900 is an example of an internal configuration of a computing device. The system 900 may be used to implement the integrated circuit design service infrastructure 810, and/or to generate a file that generates a circuit representation of an integrated circuit design that includes the circuitry shown and described in FIGS. 1-4.

The processor 902 can be a central processing unit (CPU), such as a microprocessor, and can include single or multiple processors having single or multiple processing cores. Alternatively, the processor 902 can include another type of device, or multiple devices, now existing or hereafter developed, capable of manipulating or processing information. For example, the processor 902 can include multiple processors interconnected in any manner, including hardwired or networked, including wirelessly networked. In some implementations, the operations of the processor 902 can be distributed across multiple physical devices or units that can be coupled directly or across a local area or other suitable type of network. In some implementations, the processor 902 can include a cache, or cache memory, for local storage of operating data or instructions. The system 900 can include components or units, such as a processor 902, a bus 904, a memory 906, peripherals 914, a power source 916, a network communication interface 918, a user interface 920, other suitable components, or a combination thereof.

The memory 906 can include volatile memory, non-volatile memory, or a combination thereof. For example, the memory 906 can include volatile memory, such as one or more dynamic random access memory (DRAM) modules such as double data rate (DDR) synchronous DRAM (SDRAM), and non-volatile memory, such as a disk drive, a solid-state drive, flash memory, Phase-Change Memory (PCM), or any form of non-volatile memory capable of persistent electronic information storage, such as in the absence of an active power supply. The memory 906 can include another type of device, or multiple devices, now existing or hereafter developed, capable of storing data or instructions for processing by the processor 902. The processor 902 can access or manipulate data in the memory 906 via the bus 904. Although shown as a single block in FIG. 8, the memory 906 can be implemented as multiple units. For example, a system 900 can include volatile memory, such as random access memory (RAM), and persistent memory, such as a hard drive or other storage.

The memory 906 can include executable instructions 908, data, such as application data 910, an operating system 912, or a combination thereof, for immediate access by the processor 902. The executable instructions 908 can include, for example, one or more application programs, which can be loaded or copied, in whole or in part, from non-volatile memory to volatile memory to be executed by the processor 902. The executable instructions 908 can be organized into programmable modules or algorithms, functional programs, codes, code segments, or combinations thereof to perform various functions described herein. For example, the executable instructions 908 can include instructions executable by the processor 902 to cause the system 900 to automatically, in response to a command, generate an integrated circuit design and associated test results based on a design parameters data structure. The application data 910 can include, for example, user files, database catalogs or dictionaries, configuration information or functional programs, such as a web browser, a web server, a database server, or a combination thereof. The operating system 912 can be, for example, Microsoft Windows®, macOS®, or Linux®; an operating system for a small device, such as a smartphone or tablet device; or an operating system for a large device, such as a mainframe computer. The memory 906 can comprise one or more devices and can utilize one or more types of storage, such as solid-state or magnetic storage.

The peripherals 914 can be coupled to the processor 902 via the bus 904. The peripherals 914 can be sensors or detectors, or devices containing any number of sensors or detectors, which can monitor the system 900 itself or the environment around the system 900. For example, a system 900 can contain a temperature sensor for measuring temperatures of components of the system 900, such as the processor 902. Other sensors or detectors can be used with the system 900, as can be contemplated. In some implementations, the power source 916 can be a battery, and the system 900 can operate independently of an external power distribution system. Any of the components of the system 900, such as the peripherals 914 or the power source 916, can communicate with the processor 902 via the bus 904.

The network communication interface 918 can also be coupled to the processor 902 via the bus 904. In some implementations, the network communication interface 918 can comprise one or more transceivers. The network communication interface 918 can, for example, provide a connection or link to a network, such as the network 806 shown in FIG. 8, via a network interface, which can be a wired network interface, such as Ethernet, or a wireless network interface. For example, the system 900 can communicate with other devices via the network communication interface 918 and the network interface using one or more network protocols, such as Ethernet, transmission control protocol (TCP), Internet protocol (IP), power line communication (PLC), Wi-Fi, infrared, general packet radio service (GPRS), global system for mobile communications (GSM), code division multiple access (CDMA), or other suitable protocols.

A user interface 920 can include a display; a positional input device, such as a mouse, touchpad, touchscreen, or the like; a keyboard; or other suitable human or machine interface devices. The user interface 920 can be coupled to the processor 902 via the bus 904. Other interface devices that permit a user to program or otherwise use the system 900 can be provided in addition to or as an alternative to a display. In some implementations, the user interface 920 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 914. The operations of the processor 902 can be distributed across multiple clients or servers, which can be coupled directly or across a local area or other suitable type of network. The memory 906 can be distributed across multiple clients or servers, such as network-based memory or memory in multiple clients or servers performing the operations of clients or servers. Although depicted here as a single bus, the bus 904 can be composed of multiple buses, which can be connected to one another through various bridges, controllers, or adapters.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In some implementations, the circuit representation may take the form of a hardware description language (HDL) program, a register-transfer level (RTL) data structure, a flexible intermediate representation for register-transfer level (FIRRTL) data structure, a Graphic Design System II (GDSII) data structure, a netlist, or a combination thereof. In some implementations, the integrated circuit may take the form of a field programmable gate array (FPGA), application specific integrated circuit (ASIC), system-on-a-chip (SoC), or some combination thereof. A computer may process the circuit representation in order to program or manufacture an integrated circuit, which may include programming a field programmable gate array (FPGA) or manufacturing an application specific integrated circuit (ASIC) or a system on a chip (SoC). In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming.

In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit.

In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

In a first aspect, the subject matter described in this specification can be embodied in a method that includes reconfiguring a prefetcher associated with a processor core responsive to a context switch where the processor core changes from executing a first process to a second process. In some implementations, reconfiguring the prefetcher includes updating a register controlling an operation of the prefetcher from a first set of parameters associated with the first process to a second set of parameters associated with the second process. In some implementations, the second set of parameters is based on input from a process executed in a user mode. In some implementations, the register is located to enable updating the register with the second set of parameters after using the prefetcher with the first set of parameters during run time. In some implementations, the second process is a new process, and wherein the second set of parameters is a default set of parameters. In some implementations, reconfiguring the prefetcher resets the prefetcher to prevent the second process from accessing data associated with the first process. In some implementations, reconfiguring the prefetcher comprises a kernel of an operating system executing in a higher privileged mode receiving input from a data structure and reconfiguring the prefetcher based on the input, wherein the data structure is writeable by a process when the process is executing in a lower privileged mode associated with a user mode. In some implementations, reconfiguring the prefetcher comprises the first process reconfiguring the prefetcher for the second process. In some implementations, reconfiguring the prefetcher comprises the second process reconfiguring the prefetcher for the second process. In some implementations, reconfiguring the prefetcher comprises resetting training data associated with the prefetcher. In some implementations, the method further comprises tagging the processor core with a privilege mode method with the first process and resetting the prefetcher, in connection with the context switch, to clear a history associated with the first process.

In a second aspect, the subject matter described in this specification can be embodied in a system that includes: a processor core; and a prefetcher associated with the processor core, wherein the prefetcher is reconfigured responsive to a context switch where the processor core changes from executing a first process to a second process. In some implementations, reconfiguring the prefetcher includes updating a register controlling an operation of the prefetcher from a first set of parameters associated with the first process to a second set of parameters associated with the second process. In some implementations, the second set of parameters is based on input from a process executed in a user mode. In some implementations, the register is located to enable updating the register with the second set of parameters after using the prefetcher with the first set of parameters during run time. In some implementations, the second process is a new process, and wherein the second set of parameters is a default set of parameters. In some implementations, the prefetcher associated with the processor core is a first prefetcher associated with a first processor core, and further comprising migrating the second process to a second processor core and updating a register controlling an operation of a second prefetcher associated with the second processor core to the second set of parameters associated with the second process. In some implementations, reconfiguring the prefetcher resets the prefetcher to prevent the second process from accessing data associated with the first process. In some implementations, reconfiguring the prefetcher comprises a kernel of an operating system executing in a higher privileged mode receiving an input from a data structure and reconfiguring the prefetcher based on the input, wherein the data structure is writeable by a process when the process is executing in a lower privileged mode associated with a user mode. In some implementations, reconfiguring the prefetcher comprises the first process reconfiguring the prefetcher for the second process. In some implementations, reconfiguring the prefetcher comprises the second process reconfiguring the prefetcher for the second process. In some implementations, reconfiguring the prefetcher comprises resetting training data associated with the prefetcher. In some implementations, the processor core is tagged with a privilege mode associated with the first process and the prefetcher is reset, in connection with the context switch, to clear a history associated with the first process.

In a third aspect, the subject matter described in this specification can be embodied in a method that includes reconfiguring a prefetcher associated with a processor core responsive to a context switch where the processor core changes from executing a first process to a second process, where the prefetcher is reconfigured based on input from a third process executed in a user mode. In some implementations, the second process is a same process as the third process. In some implementations, reconfiguring the prefetcher includes updating a register controlling an operation of the prefetcher from a first set of parameters associated with the first process to a second set of parameters associated with the second process. In some implementations, the second set of parameters is based on input from a process executed in a user mode. In some implementations, the register is located to enable updating the register with the second set of parameters after using the prefetcher with the first set of parameters during run time. In some implementations, the second process is a new process, and wherein the second set of parameters is a default set of parameters. In some implementations, reconfiguring the prefetcher resets the prefetcher to prevent the second process from accessing data associated with the first process. In some implementations, reconfiguring the prefetcher comprises a kernel of an operating system executing in a higher privileged mode receiving input from a data structure and reconfiguring the prefetcher based on the input, wherein the data structure is writeable by a process when the process is executing in a lower privileged mode associated with a user mode. In some implementations, reconfiguring the prefetcher comprises the first process reconfiguring the prefetcher for the second process. In some implementations, reconfiguring the prefetcher comprises the second process reconfiguring the prefetcher for the second process. In some implementations, reconfiguring the prefetcher comprises resetting training data associated with the prefetcher. In some implementations, the method further comprises tagging the processor core with a privilege mode method with the first process and resetting the prefetcher, in connection with the context switch, to clear a history associated with the first process.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent arrangements.

1. A method comprising:
using, based on a first execution of a first process by a processor core, a first set of parameters for a prefetcher;
determining a second set of parameters based on a context switch that is associated with a change from the first execution of the first process to a second execution of a second process by the processor core, wherein the second set of parameters is associated with a memory access pattern; and
reconfiguring the prefetcher for the second execution based on the second set of parameters.

2. The method of claim 1, wherein reconfiguring the prefetcher includes updating a register controlling an operation of the prefetcher from the first set of parameters associated with the first process to the second set of parameters associated with the second process.

3. The method of claim 2, wherein the second set of parameters is based on input from a process executed in a user mode.

4. The method of claim 2, wherein the register is located to enable updating the register with the second set of parameters after using the prefetcher with the first set of parameters during run time.

5. The method of claim 2, wherein the second process is a new process, and wherein the second set of parameters is a default set of parameters.

6. The method of claim 2, wherein the prefetcher associated with the processor core is a first prefetcher associated with a first processor core, and further comprising migrating the second process to a second processor core and updating a register controlling an operation of a second prefetcher associated with the second processor core to the second set of parameters associated with the second process.

7. The method of claim 1, wherein reconfiguring the prefetcher comprises a kernel of an operating system executing in a higher privileged mode receiving input from a data structure and reconfiguring the prefetcher based on the input, wherein the data structure is writeable by a process when the process is executing in a lower privileged mode associated with a user mode.

8. The method of claim 1, wherein reconfiguring the prefetcher comprises the first process reconfiguring the prefetcher for the second process.

9. The method of claim 1, wherein reconfiguring the prefetcher comprises the second process reconfiguring the prefetcher for the second process.

10. The method of claim 1, wherein reconfiguring the prefetcher resets the prefetcher to prevent the second process from accessing data associated with the first process.

11. The method of claim 1, wherein reconfiguring the prefetcher comprises resetting training data associated with the prefetcher.

12. The method of claim 1, further comprising:
tagging the processor core with a privilege mode associated with the first process and resetting the prefetcher, in connection with the context switch, to clear a history associated with the first process.

13. A system comprising:
a processor core; and
a prefetcher associated with the processor core, wherein:
based on a first execution of a first process by the processor core, the prefetcher is configured to use a first set of parameters; and
based on a context switch that is associated with a change from the first execution of the first process to a second execution of a second process by the processor core, the prefetcher is reconfigured to use a second set of parameters, wherein the second set of parameters is associated with a memory access pattern.

14. The system of claim 13, wherein reconfiguring the prefetcher includes updating a register controlling an operation of the prefetcher from the first set of parameters associated with the first process to the second set of parameters associated with the second process.

15. The system of claim 14, wherein a register is located to enable updating the register with the second set of parameters after using the prefetcher with the first set of parameters during run time.

16. The system of claim 13, wherein the second set of parameters is based on input from a process executed in a user mode.

17. One or more non-transitory computer-readable storage media storing instructions, that upon execution, cause operations comprising:
using, based on a first execution of a first process by a processor core, a first set of parameters for a prefetcher;
determining a second set of parameters based on a context switch that is associated with a change from the first execution of the first process to a second execution of a second process by the processor core, wherein the second set of parameters is associated with a memory access pattern; and
reconfiguring the prefetcher for the second execution based on the second set of parameters.

18. The one or more non-transitory computer-readable storage media of claim 17, wherein the prefetcher is reconfigured further based on input from a third process executed in a user mode, wherein the second process is a same process as the third process.

19. The one or more non-transitory computer-readable storage media of claim 17, wherein reconfiguring the prefetcher includes updating a register controlling an operation of the prefetcher from a first set of parameters associated with the first process to a second set of parameters associated with the second process.

20. The one or more non-transitory computer-readable storage media of claim 19, wherein the second set of parameters is based on input from a process executed in a user mode.
